(19) United States
(12) Patent Application Publication
(10) Pub. No.: US 2023/0416546 A1
(43) Pub. Date: Dec. 28, 2023

(54) Ink Jet Ink Composition And Ink Receiving Body

(71) Applicant: SEIKO EPSON CORPORATION, Tokyo (JP)

(72) Inventors: Ryota IMAI, Shiojiri (JP); Kazuki SHIMURA, Matsumoto (JP)

(21) Appl. No.: 18/127,036

(22) Filed: Mar. 28, 2023

(30) Foreign Application Priority Data
Mar. 29, 2022 (JP) 2022-053038

(51) Int. Cl. C09D 11/328; C09D 11/38; B41J 2/175

(52) U.S. Cl. CPC C09D 11/328; B41J 2/17503; C09D 11/38

(57) ABSTRACT

An ink jet ink composition of the present disclosure includes a sublimation dye; an anionic dispersant; and an anionic surfactant, the sublimation dye includes at least one selected from the group consisting of C.I. Disperse Orange 25, C.I. Disperse Orange 80, C.I. Solvent Orange 60, C.I. Disperse Brown 27, C.I. Disperse Violet 28, and C.I. Solvent Violet 13, and the anionic surfactant includes at least one selected from the group consisting of a polyoxyethylene alkyl ether sulfate, a polyoxyethylene alkenyl ether sulfate, a polyoxyethylene aryl ether sulfate, and a polyoxyethylene alkyl ether phosphate.

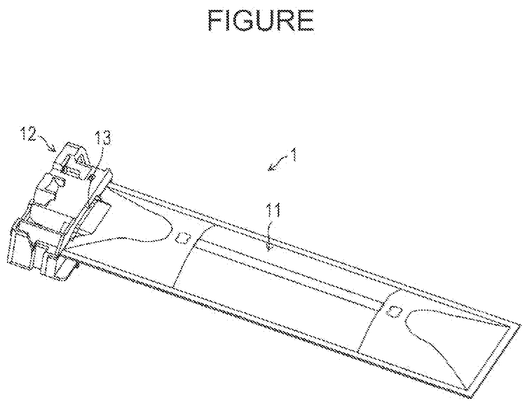

The present application is based on, and claims priority from JP Application Serial Number 2022-053038, filed Mar. 29, 2022, the disclosure of which is hereby incorporated by reference herein in its entirety.

### BACKGROUND

### 1. Technical Field

The present disclosure relates to an ink jet ink composition and an ink receiving body.

### 2. Related Art

An ink jet recording method has not only been used for recording of an image on a medium, such as paper, but has also been tried to be applied for printing on a cloth, and for ink jet printing purposes, various types of ink compositions and recording methods have been studied. For example, JP-A-2021-17510 has disclosed a water-based ink jet ink composition containing at least one specific dye selected from the group consisting of C.I. Disperse Orange 25 and C.I. Disperse Brown 27, an anionic dispersant, and at least one substance A selected from the group consisting of a polyalkylene glycol, a derivative of a polyalkylene glycol, and a phenylazo compound different from the specific dye described above.

However, the water-based ink jet ink composition disclosed in JP-A-2021-17510 has a problem such that foreign material in the form of aggregate caused by materials is generated in an ink receiving body.

### SUMMARY

According to an aspect of the present disclosure, there is provided an ink jet ink composition comprising: a sublimation dye; an anionic dispersant; and an anionic surfactant, the sublimation dye includes at least one selected from the group consisting of C.I. Disperse Orange 25, C.I. Disperse Orange 80, C.I. Disperse Brown 27, C.I. Solvent Orange 60, C.I. Solvent Violet 13, and C.I. Disperse Violet 28, and the anionic surfactant includes at least one selected from the group consisting of a polyoxyethylene alkyl ether sulfate, a polyoxyethylene alkenyl ether sulfate, a polyoxyethylene aryl ether sulfate, and a polyoxyethylene alkyl ether phosphate.

### BRIEF DESCRIPTION OF THE DRAWINGS

FIGURE is a schematic view showing one example of an ink receiving body.

### DESCRIPTION OF EXEMPLARY EMBODIMENTS

Hereinafter, although an embodiment (hereinafter, referred to as “this embodiment”) of the present disclosure will be described in detail, the present disclosure is not limited thereto and may be variously changed and/or modified without departing from the scope thereof.

### 1. Ink Jet Ink Composition

An ink jet ink composition (hereinafter, referred to as “ink composition” in some cases) of this embodiment includes: a sublimation dye; an anionic dispersant; and an anionic surfactant, the sublimation dye includes at least one selected from the group consisting of C.I. Disperse Orange 25, C.I. Disperse Orange 80, C.I. Disperse Brown 27, C.I. Solvent Orange 60, C.I. Solvent Violet 13, and C.I. Disperse Violet 28, and the anionic surfactant includes at least one selected from the group consisting of a polyoxyethylene alkyl ether sulfate, a polyoxyethylene alkenyl ether sulfate, a polyoxyethylene aryl ether sulfate, and a polyoxyethylene alkyl ether phosphate.

According to this embodiment, an ink composition which effectively prevents generation of foreign material in the form of aggregate caused by materials in an ink receiving body can be obtained.

Although the reason the excellent effect as described above is obtained according to this embodiment has not been clearly understood, the present inventors consider as described below.

First, when the ink receiving body is stored for a long period of time while inner walls thereof are in close contact with the ink composition filled in the ink receiving body, the generation of foreign material in the form of aggregate caused by the materials is liable to occur. In particular, when the inner wall material of the ink receiving body is a polyolefin, such as a polyethylene, and when the ink composition to be received includes, as the sublimation dye, at least one selected from the group consisting of C.I. Disperse Orange 25, C.I. Disperse Orange 80, C.I. Disperse Brown 27, C.I. Solvent Orange 60, C.I. Solvent Violet 13, and C.I. Disperse Violet 28, the foreign material is liable to be seriously generated.

In a narrow and small space formed by the inner walls of the ink receiving body placed with a short distance therebetween, since moisture contained in the ink composition is absorbed in a polyolefin, such as a polyethylene, the inner walls are swelled, and a dye concentration is locally increased thereby. Hence, a dispersion state of the dye in the ink composition is degraded, and as a result, the generation of foreign material is considered to occur.

In addition, although the aggregation is liable to proceed in a high temperature environment, when heat is applied to the ink receiving body, since moisture absorption by a polyolefin is further promoted, the aggregation is considered to be more liable to proceed.

In addition, the ink composition of this embodiment includes, besides the sublimation dye, the anionic dispersant and the at least one anionic surfactant selected from the group consisting of a polyoxyethylene alkyl ether sulfate, a polyoxyethylene alkenyl ether sulfate, a polyoxyethylene aryl ether sulfate, and a polyoxyethylene alkyl ether phosphate. Although an anionic dispersant adsorbs to the dye, since those anionic surfactants are each more likely to adsorb to the dye, compared to an ink composition only containing an anionic dispersant, the electric charge of the dye tends to be shifted to a negative side. Accordingly, since the electrostatic repulsion is increased, the dispersion of the dye is stabilized.

Furthermore, those anionic surfactants are each more likely to adsorb to a polyolefin forming the inner wall of the ink receiving body. Hence, the electric charge of the inner wall surface is also shifted to a negative side, the electrostatic repulsion between the inner wall and the dye is also increased, and as a result, the dispersion is more stabilized.

In addition, since those anionic surfactants each have an ethylene oxide structure, the compatibility thereof with the components contained in the ink composition is high, and an effect to improve the dispersion stability is further enhanced.

From those described above, the present inventors considered such that according to this embodiment, an ink composition which can effectively prevent the generation of foreign material in the form of aggregate caused by the materials in the ink receiving body can be obtained. However, the reason is not limited to that described above.

Next, the components contained in the ink composition will be respectively described.

### 1.1. Sublimation Dye

The ink composition of this embodiment contains a sublimation dye. The sublimation dye includes at least one selected from the group consisting of C.I. Disperse Orange 25, C.I. Disperse Orange 80, C.I. Disperse Brown 27, C.I. Solvent Orange 60, C.I. Solvent Violet 13, and C.I. Disperse Violet 28. In addition, in this specification, the “sublimation dye” indicates a dye to be sublimated by heating. The sublimation dye may be used alone, or at least two types thereof may be used in combination. Among the sublimation dyes mentioned above, C.I. Disperse Orange 25 is more liable to generate foreign material in the form of aggregate. However, according to the ink composition of this embodiment, even when C.I. Disperse Orange 25 which liable to generated foreign material as described above is contained, the generation of foreign material can be effectively prevented.

Since the ink composition which can effectively prevent the generation of foreign material in the ink receiving body can be obtained, a total content of C.I. Disperse Orange 25, C.I. Disperse Orange 80, C.I. Disperse Brown 27, C.I. Solvent Orange 60, C.I. Solvent Violet 13, and C.I. Disperse Violet 28 with respect to a total mass of the ink composition is preferably 0.05 to 30 percent by mass, more preferably 0.1 to 20 percent by mass, further preferably 0.5 to 10 percent by mass, and particularly preferably 1.0 to 5.0 percent by mass.

### 1.2. Anionic Dispersant

The ink composition of this embodiment contains an anionic dispersant. The anionic dispersant is not particularly limited as long as being ionized into an anion. In addition, in this specification, the anionic dispersant is different from an anionic surfactant. The anionic dispersant is preferably added when a dye dispersion liquid of the sublimation dye is prepared. The anionic dispersant may be used alone, or at least two types thereof may be used in combination.

Since the effect to improve the dispersion stability of the dye is further enhanced, and the generation of foreign material in the ink receiving body can be more effectively prevented, a weight average molecular weight Mw of the anionic dispersant is preferably 1,000 to 20,000, more preferably 2,000 to 10,000, and further preferably 3,000 to 5,000. In this specification, the weight average molecular weight is obtained based on a polystyrene conversion value using a gel permeation chromatography, that is, a so-called GPC.

As the anionic dispersant, a compound having a sulfo group or its salt and an aromatic ring in its structure is preferable, and a compound having a sulfonate salt and an aromatic ring is more preferable. Since the anionic dispersant as described above is used, the effect to improve the dispersion stability of the dye is further enhanced, and the generation of foreign material in the ink receiving body tends to be more effectively prevented.

As the anionic dispersant, at least one selected from the group consisting of a compound represented by the following formula (2), a naphthalenesulfonic acid formalin condensate sodium salt, and a sodium lignosulfonate is preferably contained. Those anionic dispersants are each able to further enhance the effect to improve the dispersion stability of the dye and each also tend to more effectively prevent the generation of foreign material in the ink receiving body.

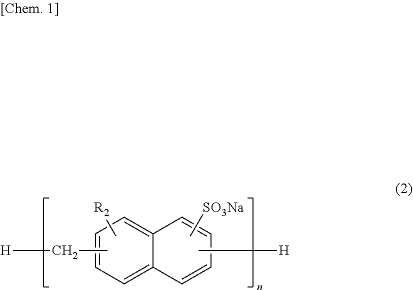

In the formula (2), R2 represents a monovalent hydrocarbon group having 1 to 4 carbon atoms, and n represents an integer of 1 or more.

As the monovalent hydrocarbon group having 1 to 4 carbon atoms represented by R₂, for example, there may be mentioned a linear or a branched alkyl group, such as a methyl group, an ethyl group, an n-propyl group, an iso propyl group, an n-butyl group, an iso-butyl group, or a 1,1-dimethylpropyl group; or a linear or a branched alkenyl group such as a vinyl group or an allyl group. Among those mentioned above, since the effect to improve the dispersion stability of the dye is further enhanced, and the generation of foreign material in the ink receiving body tends to be more effectively prevented, as R₂, an n-butyl group or an iso-butyl group is preferable, and an n-butyl group is more preferable. Since the effect to improve the dispersion stability of the dye is further enhanced, and the generation of foreign material in the ink receiving body tends to be more effectively prevented, as the compound represented by the formula (2), an n-butylnaphthalenesulfonic acid formalin condensate sodium salt is preferable.

In addition, n is an integer of preferably 1 to 50, more preferably 1 to 30, and further preferably 1 to 20.

Since the effect to improve the dispersion stability of the dye is further enhanced, and the generation of foreign material in the ink receiving body tends to be more effectively prevented, a content of the anionic dispersant with respect to the total mass of the ink composition is preferably 0.05 to 30 percent by mass, more preferably 0.1 to 20 percent by mass, even more preferably 0.5 to 10 percent by mass, and further preferably 1.0 to 5.0 percent by mass.

### 1.3. Anionic Surfactant

The ink composition of this embodiment contains an anionic surfactant. The anionic surfactant includes at least one selected from the group consisting of a polyoxyethylene alkyl ether sulfate, a polyoxyethylene alkenyl ether sulfate, a polyoxyethylene aryl ether sulfate, and a polyoxyethylene alkyl ether phosphate. Since those anionic surfactants are each likely to adsorb to the sublimation dye and the inner wall of the ink receiving body and each also have a high compatibility with the components contained in the ink composition, the effect to improve the dispersion stability of the dye is enhanced, and the generation of foreign material in the ink receiving body tends to be effectively prevented. The anionic surfactant is preferably added together with the dye dispersion liquid when the ink composition is prepared. The anionic surfactant may be used alone, or at least two types thereof may be used in combination.

As the salt, for example, there may be mentioned a salt of an alkali metal, such as potassium or sodium, in group I of the periodic table; or a salt of an alkaline earth metal, such as calcium or magnesium, in group II of the periodic table. Among those mentioned above, since the effect to improve the dispersion stability of the dye is further enhanced, and the generation of foreign material in the ink receiving body tends to be more effectively prevented, a salt of an alkali metal in group I of the periodic table is preferable, a potassium salt or a sodium salt is more preferable, and a sodium salt is further preferable.

As the polyoxyethylene alkyl ether sulfate, for example, a polyoxyethylene alkyl ether sulfate in which the polymerization number of ethylene oxide units is 1 to 30 and the number of carbon atoms of the alkyl group is 1 to 50 may be mentioned. Since the effect to improve the dispersion stability of the dye is further enhanced, and the generation of foreign material in the ink receiving body tends to be more effectively prevented, a polyoxyethylene alkyl ether sulfate in which the polymerization number of ethylene oxide units is 1 to 20 and the number of carbon atoms of the alkyl group is 10 to 40 is preferable.

As the polyoxyethylene alkyl ether sulfate described above, for example, there may be mentioned a polyoxyethylene lauryl ether sulfate in which the polymerization number of ethylene oxide units is 1 to 20, a polyoxyethylene myristyl ether sulfate in which the polymerization number of ethylene oxide units is 1 to 20, a polyoxyethylene cetyl ether sulfate in which the polymerization number of ethylene oxide units is 1 to 20, a polyoxyethylene stearyl ether sulfate in which the polymerization number of ethylene oxide units is 1 to 20, a polyoxyethylene oleyl ether sulfate in which the polymerization number of ethylene oxide units is 1 to 20, or a polyoxyethylene alkyl ether sulfate in which the polymerization number of ethylene oxide units is 1 to 20 and the number of carbon atoms of the alkyl group is 10 to 40. The polyoxyethylene alkyl ether sulfate may be used alone, or at least two types thereof may be used in combination.

As the polyoxyethylene alkenyl ether sulfate, for example, a polyoxyethylene alkenyl ether sulfate in which the polymerization number of ethylene oxide units is 1 to 30 and the number of carbon atoms of the alkenyl group is 1 to 50 may be mentioned. Since the effect to improve the dispersion stability of the dye is further enhanced, and the generation of foreign material in the ink receiving body can be more effectively prevented, a polyoxyethylene alkenyl ether sulfate in which the polymerization number of ethylene oxide units is 1 to 25 and the number of carbon atoms of the alkenyl group is 10 to 40 is preferable.

As the polyoxyethylene alkenyl ether sulfate as described above, for example, a sodium polyoxyethylene oleyl ether sulfate in which the polymerization number of ethylene oxide units is 1 to 25 may be mentioned.

As the polyoxyethylene aryl ether sulfate, for example, a polyoxyethylene aryl ether sulfate in which the polymerization number of ethylene oxide units is 1 to 30 and the number of carbon atoms of the aryl group is 1 to 50 may be mentioned. Since the effect to improve the dispersion stability of the dye is further enhanced, and the generation of foreign material in the ink receiving body can be more effectively prevented, a polyoxyethylene aryl ether sulfate in which the polymerization number of ethylene oxide units is 1 to 20 and the number of carbon atoms of the aryl group is 10 to 40 is preferable.

As the polyoxyethylene aryl ether sulfate as described above, for example, there may be mentioned a polyoxyethylene phenyl ether sulfate in which the polymerization number of ethylene oxide units is 1 to 20, a polyoxyethylene monostyrenated phenyl ether sulfate in which the polymerization number of ethylene oxide units is 1 to a polyoxyethylene distyrenated phenyl ether sulfate in which the polymerization number of ethylene oxide units is 1 to 20, a polyoxyethylene tristyrenated phenyl ether sulfate in which the polymerization number of ethylene oxide units is 1 to 20, or a polyoxyethylene polycyclic phenyl ether sulfate in which the polymerization number of ethylene oxide units is 1 to 20. Since the effect to improve the dispersion stability of the dye is further enhanced, and the generation of foreign material in the ink receiving body can be more effectively prevented, among those mentioned above, a polyoxyethylene tristyrenated phenyl ether sulfate in which the polymerization number of ethylene oxide units is to 16 is preferable. The polyoxyethylene aryl ether sulfate may be used alone, or at least two types thereof may be used in combination.

As the polyoxyethylene alkyl ether phosphate, for example, a polyoxyethylene alkyl ether phosphate in which the polymerization number of ethylene oxide units is 1 to 30 and the number of carbon atoms of the alkyl group is 1 to 50 may be mentioned. Since the effect to improve the dispersion stability of the dye is further enhanced, and the generation of foreign material in the ink receiving body can be more effectively prevented, a polyoxyethylene alkyl ether phosphate in which the polymerization number of ethylene oxide units is 1 to 20 and the number of carbon atoms of the alkyl group is 10 to 40 is preferable.

As the polyoxyethylene alkyl ether phosphate as described above, for example, there may be mentioned a polyoxyethylene lauryl ether phosphate in which the polymerization number of ethylene oxide units is 1 to 20, a polyoxyethylene myristyl ether phosphate in which the polymerization number of ethylene oxide units is 1 to 20, a polyoxyethylene cetyl ether phosphate in which the polymerization number of ethylene oxide units is 1 to 20, a polyoxyethylene stearyl ether phosphate in which the polymerization number of ethylene oxide units is 1 to 20, a polyoxyethylene oleyl ether phosphate in which the polymerization number of ethylene oxide units is 1 to 20, or a polyoxyethylene alkyl ether phosphate in which the polymerization number of ethylene oxide units is 5 to 15 and the number of carbon atoms of the alkyl group is 10 to 20. Since the effect to improve the dispersion stability of the dye is further enhanced, and the generation of foreign material in the ink receiving body can be more effectively prevented, among those mentioned above, a polyoxyethylene alkyl ether phosphate in which the polymerization number of ethylene oxide units is 10 and the number of carbon atoms of the alkyl group is 12 to 15 is preferable. The polyoxyethylene alkyl ether phosphate may be used alone, or at least two types thereof may be used in combination.

As the anionic surfactant, a compound represented by the following formula (1) is more preferably contained. Since the compound represented by the formula (1) is more likely to adsorb to the sublimation dye and the inner wall of the ink receiving body and has a higher compatibility with the components contained in the ink composition, the effect to improve the dispersion stability of the dye is further enhanced, and the generation of foreign material in the ink receiving body tends to be more effectively prevented.

R₁O(CH₂CH₂O)ₘSO₃⁻M⁺ (1)

In the formula (1), R₁ represents an alkyl group having 10 to 50 carbon atoms, an alkenyl group having 10 to 50 carbon atoms, or an aryl group having 10 to 50 carbon atoms. M⁺ represents an alkali metal ion. In addition, m represents the polymerization number of ethylene oxide units and is an integer of 1 to 30.

As the alkyl group having 10 to 50 carbon atoms represented by R₁, a linear or a branched alkyl group having 11 to 40 carbon atoms is preferably mentioned.

As the alkyl group as described above, for example, there may be mentioned decyl group, isodecyl group, dodecyl group, isododecyl group, tridecyl group, tetradecyl group, pentadecyl group, hexadecyl group, heptadecyl group, octadecyl group, nonadecyl group, myricyl group, undecyl group, lauryl group, myristyl group, cetyl group, stearyl group, butyloctyl group, icosyl group, behenyl group, or catetyl group. Since the effect to improve the dispersion stability of the dye is further enhanced, and the generation of foreign material in the ink receiving body can be more effectively prevented, among those mentioned above, a lauryl group is preferable.

As the alkenyl group having 10 to 50 carbon atoms represented by R₁, a linear or a branched alkenyl group having 11 to 40 carbon atoms is preferably mentioned.

As the alkenyl group as described above, for example, there may be mentioned decenyl group, undecenyl group, dodecenyl group, tetradecenyl group, octadecenyl group, oleyl group, linoleyl group, cyclopentenyl group, cyclohexenyl group, methylcyclopentenyl group, or methylcyclohexenyl group. Since the effect to improve the dispersion stability of the dye is further enhanced, and the generation of foreign material in the ink receiving body can be more effectively prevented, among those mentioned above, an oleyl group is preferable.

As the aryl group having 10 to 50 carbon atoms represented by RI, an aryl group having preferably 11 to 40 carbon atoms and more preferably 13 to 20 carbon atoms may be mentioned.

As the aryl group as described above, for example, there may be mentioned naphthalene group, biphenyl group, terphenyl group, phenanthryl group, anthracenyl group, isopropylphenyl group, butylphenyl group, t-butylphenyl group, di-t-butylphenyl group, monostyrenated phenyl group, distyrenated phenyl group, tristyrenated phenyl group, tetrastyrenated phenyl group, pentastyrenated phenyl group, monostyrenated naphthalene group, distyrenated naphthalene group, tristyrenated naphthalene group, tetrastyrenated naphthalene group, pentastyrenated naphthalene group, or polycyclic phenyl group. Since the effect to improve the dispersion stability of the dye is further enhanced, and the generation of foreign material in the ink receiving body can be more effectively prevented, among those mentioned above, a tristyrenated phenyl group is preferable.

Since the effect to improve the dispersion stability of the dye is further enhanced, and the generation of foreign material in the ink receiving body can be more effectively prevented, as the M⁺, a potassium ion or a sodium ion is preferable, and a sodium ion is more preferable.

In addition, m represents an integer of 1 to 20.

Since the effect to improve the dispersion stability of the dye is further enhanced, and the generation of foreign material in the ink receiving body can be more effectively prevented, when R₁ represents an aryl group having 10 to 50 carbon atoms, m is preferably 10 to 18 and more preferably 15 or 16.

As the anionic surfactant, a commercial product may also be used. As the commercial product, for example, there may be mentioned EMAL (registered trademark) 327 or 170J or LATEMUL (registered trademark) WX (trade name, manufactured by Kao Corporation); NIKKOL (registered trademark) DDP-10 (trade name, Nikko Chemicals Co., Ltd.); or SM-210 (trade name, manufactured by Toho Chemical Industry Co., Ltd.).

A total content of the polyoxyethylene alkyl ether sulfate, the polyoxyethylene alkenyl ether sulfate, the polyoxyethylene aryl ether sulfate, and the polyoxyethylene alkyl ether phosphate with respect to the total mass of the ink composition is preferably 0.05 to 2.0 percent by mass and more preferably 0.1 to 1.5 percent by mass. When the anionic surfactant is contained in the ink composition at the content in the range described above, since the anionic surfactant is more likely to adsorb to the sublimation dye and the inner wall of the ink receiving body and has a higher compatibility with the components contained in the ink composition, the effect to improve the dispersion stability of the dye is further enhanced, and the generation of foreign material in the ink receiving body tends to be more effectively prevented. In addition, the ink composition tends to have a more excellent low foaming property.

### 1.4. Phenylazo Compound

As the sublimation dye, when at least one specific dye selected from the group consisting of C.I. Disperse Orange 25, C.I. Disperse Orange 80, and C.I. Disperse Brown 27 is contained, a phenylazo compound different from the specific dye is preferably further contained. The phenylazo compound is a compound having a phenyl group and an azo group and is not particularly limited as long as being different from C.I. Disperse Orange 25, C.I. Disperse Orange 80, and C.I. Disperse Brown 27. The phenylazo compound may be used alone, or at least two types thereof may be used in combination.

In this embodiment, since the phenylazo compound is contained in the ink composition, the effect to improve the dispersion stability of the dye is further enhanced, and the generation of foreign material in the ink receiving body tends to be more effectively prevented.

As the phenylazo compound, for example, there may be mentioned C.I. Food Orange 1, 2, 3, 4, or 4:1; C.I. Acid

Orange 1 10, 10:1, 100, 12, 125, 127, 134, 137, 14, 142, 144, 148, 154, 159, 16, 160, 164, 17, 173, 18, 19, 20, 23, 27, 28, 30, 31, 41, 5, 51, 52, 56, 60, 61, 62, 7, 72, 74, 76, 8, 86, 87, 88, 88:1, 89, 9, 92, 97, or 98; C.I. Basic Orange 1, 2, 24, 25, 29, 30, 33, 54, or 69; C.I. Direct Orange 17, 18, 75, 84, or 85; C.I. Disperse Orange 1, 1:1, 127, 138, 149, 152, 157, 17, 18, 23, 25:1, 3, 3:1, 30, 31, 33, 36, 37, 41, 42, 44, 49, 5, 50, 52, 53, 56, 57, 61, 62, 67, 68, 7, 71, 73, 76, 78, 90, 96, or 97; C.I. Reactive Orange 1, 107, 113, 116, 118, 119, 12, 122, 123, 124, 125, 126, 13, 134, 135, 139, 14, 16, 2, 29, 3, 33, 35, 37, 38, 4, 56, 64, 67, 68, 7, 70, 72, 72:1, 82, 84, 86, 87, 91, 94, or 96; C.I. Solvent Orange 1, 102, 103, 105, 11, 110, 12, 2, 20, 3, 4, 4:1, 40:1, 41, 45, 49, 5, 54, 56, 6, 62, 7, 8, 81, 9, 98, or 99; C.I. Acid Red 6, 18, 57, 97, 106, 151, 249, or 260; or C.I. Acid Yellow 17, 19, 42, 49, or 79.

Among those mentioned above, at least one selected from the group consisting of C.I. Disperse Orange 30, C.I. Disperse Orange 31, and C.I. Disperse Orange 73 is preferably contained. Since at least one of those phenylazo compounds is contained in the ink composition, the effect to improve the dispersion stability of the dye is further enhanced, and the generation of foreign material in the ink receiving body tends to be more effectively prevented. Since an ink composition which has a further enhanced effect to improve the dispersion stability of the dye and which can more effectively prevent the generation of foreign material in the ink receiving body can be obtained, a content of the phenylazo compound with respect to the total mass of the ink composition is preferably 0.05 to 10 percent by mass, more preferably 0.1 to 5.0 percent by mass, and further preferably 0.5 to 1.0 percent by mass.

### 1.5. Water-Based Organic Solvent

The ink composition may contain a water-based organic solvent.

As the water-based organic solvent as described above, for example, there may be mentioned glycerin; a glycol, such as ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, or 1,6-hexanediol; a glycol monoether, such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, triethylene glycol monomethyl ether, or triethylene glycol monobutyl ether; or an alcohol, such as methanol, ethanol, n-propyl alcohol, iso-propyl alcohol, n-butanol, 2-butanol, tert-butanol, iso-butanol, n-pentanol, 2-pentanol, 3-pentanol, or tert-pentanol. The water-based organic solvent may be used alone, or at least two types thereof may be used in combination.

Among those mentioned above, a glycol is able to function as a moisture retaining agent. In addition, a glycol monoether is able to function as a penetrating agent.

In order to more effectively and reliably achieve the operational function of this embodiment, a total content of the water-based organic solvent with respect to the total mass of the ink composition is preferably 5 to 30 percent by mass.

### 1.6. Surfactant

The ink composition may contain a surfactant other than the anionic surfactant.

The surfactant has a function to adjust the wettability of the ink composition to a recording medium by decreasing the surface tension thereof. As the surfactant, for example, an acetylene glycol-based surfactant, a silicone-based surfactant, or a fluorine-based surfactant may be mentioned.

As the acetylene glycol-based surfactant, for example, there may be mentioned Surfynol (registered trademark) 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, or DF110D (manufactured by Nisshin Chemical Industry Co., Ltd.); Olfine (registered trademark) B, Y, P, A, STG, SPC, E1004, E1010, PD-001, PD-002W, PD-003, PD-004, EXP.4001, EXP.4036, EXP.4051, AF-103, AF-104, AK-02, SK-14, or AE-3 (manufactured by Nisshin Chemical Industry Co., Ltd.); or Acetylenol (registered trademark) E00, E00P, E40, or E100 (manufactured by Kawaken Fine Chemicals Co., Ltd.).

As the silicone-based surfactant, for example, a polysiloxane-based compound, such as a polyether-modified organosiloxane, may be mentioned. As a commercial product of the polyether-modified organosiloxane, for example, there may be mentioned BYK-306, BYK-307, BYK-333, BYK-341, BYK-345, BYK-346, or BYK-348 (manufactured by BYK Japan KK); or KF-351A, KF-352A, KF-353, KF-354L, KF-355A, KF-615A, KF-945, KF-640, KF-642, KF-643, KF-6004, KF-6020, X-22-4515, KF-6011, KF-6012, KF-6015, or KF-6017 (manufactured by Shin-Etsu Chemical Co., Ltd.).

As the fluorine-based surfactant, for example, a fluorine modified polymer may be mentioned. For example, BYK-340 (manufactured by BYK Japan KK) may be mentioned.

The surfactant may be used alone, or at least two types thereof may be used in combination.

Since an ink composition which has a further enhanced effect to improve the dispersion stability of the dye and which can more effectively prevent the generation of foreign material in the ink receiving body can be obtained, a content of the surfactant with respect to the total mass of the ink composition is preferably 0.01 to 10 percent by mass, more preferably 0.05 to 5.0 percent by mass, and further preferably 0.1 to 1.0 percent by mass.

### 1.7. Water

The ink composition may contain water.

As the water, for example, there may be mentioned pure water, such as ion exchange water, ultrafiltration water, reverse osmosis water, or distilled water, or water, such as ultrapure water, in which ionic impurities are removed as much as possible. In addition, when the ink composition is stored for a long time, water sterilized by UV radiation, addition of hydrogen peroxide, or the like is preferably used since the generation of bacteria and fungi can be suppressed.

A content of the water with respect to the total mass of the ink composition is preferably 30 to 80 percent by mass. Since the content of the water is set in the range described above, the viscosity of the ink composition can be suppressed from being increased.

### 1.8. Other Components

The ink composition may contain various types of additives, such as a solubilizing agent, a viscosity adjuster, a pH adjuster, an antioxidant, an UV absorber, an oxygen absorber, an antiseptic agent, a fungicide, a corrosion inhibitor, and/or a chelating agent to trap a metal ion influencing the dispersion, which are generally used in the ink composition. The additives may be used alone, or at least two types thereof may be used in combination.

Since an ink composition which has a further enhanced effect to improve the dispersion stability of the dye and which can more effectively prevent the generation of foreign material in the ink receiving body can be obtained, a total content of the additives with respect to the total mass of the ink composition is preferably 0.01 to 10 percent by mass.

### 1.9. Physical Properties of Ink Composition

A viscosity of the ink composition at 20° C. is set to preferably 1.5 to 15 mPa·s, more preferably 1.5 to 7 mPa·s, and further preferably 1.5 to 5.5 mPa·s.

In order to have an appropriate wettability to a recording medium, an upper limit of the surface tension of the ink composition at 25° C. is preferably 40 mN/m or less, more preferably 38 mN/m or less, even more preferably 35 mN/m or less, further preferably 32 mN/m or less, and particularly preferably 30 mN/m or less. In addition, from the same point as described above, a lower limit of the surface tension of the ink composition is preferably 15 mN/m or more, more preferably 20 mN/m or more, even more preferably 25 mN/m or more, and further preferably 27 mN/m or more. In addition, in this specification, as the surface tension, a surface tension measured using a surface tensiometer CBVP-Z (trade name, manufactured by Kyowa Interface Science Co., Ltd.) when a platinum plate is wetted with a composition at ordinary temperature and ordinary pressure can be used.

When the surface tension of the ink composition is in the range described above, an ejection stability and an initial filling property for the ink jet recording can be made more preferable.

### 1.10. Method for Manufacturing Ink Composition

The ink composition can be prepared such that the sublimation dye, the anionic dispersant, and the anionic surfactant are mixed together, if needed, with the phenylazo compound, the water-based organic solvent, the surfactant other than the anionic surfactant, water, and the other components in an arbitrary order, and if needed, impurities and foreign material are removed by filtration or the like. In addition, when the ink composition is manufactured, a dye dispersion liquid is preferably used which is prepared in advance such that the sublimation dye and the anionic dispersant are mixed and dispersed, if needed, with the phenylazo compound and water in an arbitrary order, and if needed, impurities and foreign materials are removed by filtration or the like. For example, when the sublimation dye and the anionic dispersant are mixed together, if needed, with the phenylazo compound and water using a mixing/dispersing machine, such as a paint shaker, a bead mill, or a ball mill, the dispersion liquid can be obtained.

As a method to mix the components, a method in which the components are sequentially charged in a container equipped with a stirring device, such as a mechanical stirrer or a magnetic stirrer, and are then mixed together by stirring may be used. As a filtration method, for example, centrifugal filtration or filter filtration may be mentioned.

### 2. Application

The ink composition effectively prevents the generation of foreign material in the form of aggregate caused by the materials in the ink receiving body. Hence, the ink composition is suitably used for a dyeing method performed on a cloth or the like using sublimation transfer. As the dyeing method using sublimation transfer, for example, there may be mentioned a method in which after printing is performed on a sheet-shaped transfer medium, such as paper, by an ink jet method using an ink jet recording apparatus, the transfer medium is laminated on a recording medium, such as a cloth, and is then sublimation-transferred by heating.

### 2.1. Ink Jet Recording Apparatus

An ink jet recording apparatus is not particularly limited as long as including at least an ink receiving body to receive an ink composition and a recording head connected thereto and being able to form an image on transfer paper functioning as an intermediate transfer medium by ejecting the ink composition from the recording head. In addition, as the ink jet recording apparatus, either a serial type or a line type may be used. In those types of ink jet recording apparatuses, the recording head is mounted, and while the relative positional relationship between the transfer paper and the recording head is changed, a liquid droplet of the ink composition having a predetermined volume is intermittently ejected at a predetermined timing from a nozzle hole of the recording head. Accordingly, the ink composition is adhered to the transfer paper, and hence, a predetermined transfer image can be formed.

In general, in the serial type ink jet recording apparatus, a transport direction of the recording medium and a direction of reciprocal movement of the recording head are intersected with each other, and by the combination between the reciprocal movement of the recording head and the transport operation of the recording medium, the relative positional relationship between the recording medium and the recording head is changed. In addition, in the case described above, in general, a plurality of nozzle holes is disposed in the recording head, and along the transport direction of the recording medium, a line of nozzle holes, that is, the nozzle line, is formed. In addition, in the recording head, in accordance with the types and the number of ink compositions, a plurality of nozzle lines may be formed in some cases.

In addition, in general, in the line type ink jet recording apparatus, the reciprocal movement of the recording head is not performed, and the relative positional relationship between the recording medium and the recording head is changed by the transport of the recording medium. In the case described above, in general, a plurality of nozzle holes is also disposed in the recording head, and a nozzle line is formed along a direction intersecting the transport direction of the recording medium.

### 2.2. Ink Receiving Body

In this embodiment, the ink receiving body is a concept to include a container and a package and refers to a body which directly or indirectly receives the ink composition. That is, in the ink receiving body, the ink composition is received. The ink receiving body is used for storage and transportation of the ink composition before the ink composition is used in the ink jet recording apparatus. In addition, when the ink composition is used in the ink jet recording apparatus, as the ink receiving body, a member to supply the ink composition received in the ink receiving body to the recording apparatus is also included.

According to the ink composition of this embodiment, the generation of foreign material in the form of aggregate caused by the materials can be effectively prevented in the ink receiving body. Hence, the ink composition can be stored in the ink receiving body with an excellent storage stability.

Even when the inner wall of the ink receiving body is composed of a polyolefin, such as a polyethylene, according to the ink composition of this embodiment, the generation of foreign material can be effectively prevented. Hence, in order to more effectively and reliably achieve the operational effect of this embodiment, the ink receiving body preferably includes a container to receive the ink composition and a connection member, and the container is preferably formed from a film containing a polyolefin. Next, with reference to FIGURE, one example of the ink receiving body as described above will be described. In addition, FIGURE is an external view of an ink receiving body 1.

The ink receiving body 1 is a body to supply the ink composition to the ink jet recording apparatus. As shown in FIGURE, the ink receiving body 1 includes a container 11 and a connection member 12. The container 11 receives the ink composition. The container 11 is preferably a flexible bag. The container 11 has a bag shape and is preferably formed from films adhered to each other. In this embodiment, two films are laminated to each other and are bonded between parts of peripheral sections thereof and between the other parts thereof with a bonding portion 13 of the connection member 12 interposed therebetween by a method such as thermal fusion, so that the container 11 is formed.

The film forming the container 11 is formed from a raw material having a flexibility and a gas barrier property. For example, as the raw material of the film, a poly(ethylene terephthalate), a nylon, or a polyolefin may be mentioned. As the polyolefin, for example, a polyethylene or a polypropylene may be mentioned. Since having an excellent film flexibility, a polyolefin is preferable, and a polyethylene is more preferable. In addition, the film may be formed using a laminate structure in which films formed from the raw material mentioned above are laminated to each other. In the laminate structure as described above, for example, an outer layer may be formed from a poly(ethylene terephthalate) or a nylon having an excellent impact resistance, and an inner layer may be formed from a polyolefin, such as a polyethylene, having an excellent ink resistance. Furthermore, a film including a layer formed by deposition of aluminum or the like may be used as one structural member of the laminate structure.

An ink receiving volume of the ink receiving body 1 is preferably 1,000 mL or more. When the ink receiving volume of the ink receiving body 1 is in the range described above, the ink receiving body 1 is able to receive a larger volume of the ink composition. In addition, in this specification, the “ink receiving volume” indicates the maximum volume of the ink composition which can be received in the ink receiving body 1.

As a concrete example of the ink receiving body, for example, a cartridge, a bag, or a tank of the ink jet recording apparatus may be mentioned.

### 3. Ink Jet Recording Method

An ink jet recording method which is a dyeing method using sublimation transfer includes a step of adhering the ink composition to a recording surface of a first recording medium, a step of disposing a second recording medium on the recording surface of the first recording medium, and a step of heating the first recording medium and the second recording medium. In other words, the sublimation transfer ink jet recording method uses an ink jet method and includes an ink application step of applying the ink composition to an intermediate transfer medium and, while a surface of the intermediate transfer medium to which the ink composition is applied is made to face a dyeing surface of an object to be dyed, a transfer step of transferring a disperse dye to the object to be dyed by heating the intermediate transfer medium to which the ink composition is applied. Accordingly, a dyed matter can be manufactured with a good productivity, and this sublimation transfer ink jet recording method is also called a method for manufacturing a dyed matter. Hereinafter, the respective steps will be described.

### 3.1. Ink Application Step

In this step, by using an ink jet method, the ink composition is applied to the recording surface of the intermediate transfer medium functioning as the first recording medium. The ejection of the ink composition by an ink jet method can be performed using a liquid droplet ejection device. As the liquid droplet ejection device as described above, for example, the ink jet recording apparatus described above may be mentioned.

As a liquid droplet ejection method which is an ink jet method, for example, a piezoelectric method or a method in which the ink composition is ejected by foam (bubbles) generated by hearing the ink composition may be mentioned. Among those methods described above, for example, since the ink composition is not likely to deteriorate, a piezoelectric method is preferable.

As the intermediate transfer medium, for example, paper, such as regular paper, or a recording medium provided with an ink receiving layer may be used. As the recording medium provided with an ink receiving layer described above, for example, ink jet exclusive paper or coated paper may be mentioned. Among those mentioned above, paper provided with an ink receiving layer containing inorganic particles, such as silica, is more preferable. Accordingly, in a process in which the ink composition applied to the intermediate transfer medium is dried, an intermediate recorded matter in which, for example, bleeding on its recording surface is suppressed can be obtained. In addition, when the medium is as described above, the disperse dye is allowed to easily stay on the recording surface, and in the following transfer step, the sublimation of the disperse dye can be more efficiently performed.

In this step, plural types of ink compositions may be used. Accordingly, for example, a color gamut to be displayed can be made wider. One of the plural types of ink compositions described above may be the ink composition of this embodiment, and at least two types thereof may be the ink compositions of this embodiment.

### 3.2. Transfer Step

Subsequently, in the state in which the recording surface of the intermediate transfer medium to which the ink composition is applied is made to face the object to be dyed, in other words, in the state in which the second recording medium is disposed on the recording surface of the first recording medium, heating is performed, so that the disperse dye forming the ink composition is transferred to the object to be dyed. Accordingly, a dyed matter including the disperse dye thus transferred is obtained.

In this step, the intermediate transfer medium to which the ink composition is applied may be heated while facing the object to be dyed. In this step, the heating is more preferably performed in the state in which the intermediate transfer medium is in close contact with the object to be dyed. Accordingly, for example, a clearer image is recorded on the second recording medium, that is, a clearer image can be dyed thereon.

As the object to be dyed, for example, a cloth, such as a hydrophobic fiber cloth, or a sheet-shaped material, such as a resin film or a plastic film, is preferably used. In addition, an object having a three-dimensional shape, such as a spherical shape or a rectangular parallelepiped shape, other than the sheet shape may also be used.

In addition, as the object to be dyed, for example, besides the object formed from a resin or a plastic, a glass, a metal, or a china coated with a hydrophobic resin may also be used. As fibers forming the cloth functioning as the object to be dyed, for example, there may be mentioned polyester fibers, nylon fibers, triacetate fibers, diacetate fibers, polyamide fibers, or blended fibers using at least two of those mentioned above. In addition, a blended product between at least one of those mentioned above and regenerated fibers, such as rayon, or natural fibers, such as cotton, silk, or wool, may also be used.

In addition, as the resin film or the plastic film functioning as the object to be dyed, for example, a polyester film, a polyurethane film, a polycarbonate film, a poly(phenylene sulfide) film, a polyimide film, or a poly(amide imide) film may be mentioned. Those films mentioned above each may be a laminate in which layers are laminated to each other or each may be formed from a gradient material in which the composition of the material is gradually changed.

Although the recording medium including a cloth may be a cloth itself, the cloth is preferably pre-treated using a pre-treatment liquid containing resin particles. Since the cloth is pre-treated, a recorded matter having a more excellent rubbing fastness tends to be obtained.

### EXAMPLES

Hereinafter, although the present disclosure will be described in more detail with reference to Examples and Comparative Examples, the present disclosure is not at all limited to the following Examples.

### 1. Preparation of Ink Jet Ink Composition

### 1.1. Preparation of Dye Dispersion Liquids 1 to 25

Components were charged in a mixture preparation tank to have one of the compositions shown in Tables 1 and 2 and were then dispersed with 0.3-mm zirconia beads using a paint shaker, so that dye dispersion liquids 1 to 25 were obtained. In addition, the numerical values of the components shown in Tables 1 and 2 each represent percent by mass.

In addition, the components shown in Tables 1 and 2 are as shown below.

### Sublimation Dye

DISPERSE ORANGE 25 C.I. Disperse Orange 25 (commercial product)
DISPERSE ORANGE 80 C.I. Disperse Orange 80 (commercial product)
DISPERSE BROWN 27 C.I. Disperse Brown 27 (commercial product)
SOLVENT ORANGE 60 C.I. Solvent Orange 60 (commercial product)
SOLVENT VIOLET 13 C.I. Solvent Violet 13 (commercial product)
DISPERSE VIOLET 28 C.I. Disperse Violet 28 (commercial product)
DISPERSE YELLOW 54 C.I. Disperse Yellow 54 (commercial product)

### Anionic Dispersant

NAPHTHALENESULFONIC ACID FORMALIN CONDENSATE Na naphthalenesulfonic acid formalin condensate sodium salt
n-BUTYLNAPHTHALENESULFONIC ACID FORMALIN CONDENSATE Na butylnaphthalenesulfonic acid formalin condensate sodium salt, compound represented by the above formula (2)
LIGNIN SULFONIC ACID Na sodium lignosulfonate Phenylazo Compound
DISPERSE ORANGE 30 C.I. Disperse Orange 30 (commercial product)
DISPERSE ORANGE 31 C.I. Disperse Orange 31 (commercial product)
DISPERSE ORANGE 73 C.I. Disperse Orange 73 (commercial product)

TABLE 1

| | | | DYE | DYE | DYE | DYE | DYE |
|---|---|---|---|---|---|---|---|
| | | | DISPERSION | DISPERSION | DISPERSION | DISPERSION | DISPERSION |
| | | | LIQUID 1 | LIQUID 2 | LIQUID 3 | LIQUID 4 | LIQUID 5 |
| DYE | SUBLIMATION | DISPERSE ORANGE 25 | 15 | 15 | 15 | 15 | 15 |
| DISPERSION | DYE | DISPERSE ORANGE 80 | | | | | |
| LIQUID | | DISPERSE BROWN 27 | | | | | |
| (PERCENT BY | | SOLVENT ORANGE 60 | | | | | |
| MASS) | | SOLVENT VIOLET 13 | | | | | |
| | | DISPERSE VIOLET 28 | | | | | |
| | | DISPERSE YELLOW 54 | | | | | |
| | ANIONIC | NAPHTHALENESULFONIC | 15 | 15 | 15 | 15 | |
| | DISPERSANT | ACID FORMALIN | | | | | |
| | | CONDENSATE Na | | | | | |
| | | BUTYLNAPHTHALENE- | | | | | 15 |
| | | SULFONIC ACID | | | | | |
| | | FORMALIN CONDENSATE | | | | | |
| | | Na | | | | | |
| | | LIGNIN SULFONIC ACID | | | | | |
| | | Na | | | | | |
| | PHENYLAZO | DISPERSE ORANGE 30 | | 1.5 | | | |
| | COMPOUND | DISPERSE ORANGE 31 | | | 1.5 | | |
| | | DISPERSE ORANGE 73 | | | | 1.5 | 1.5 |
| | PURE WATER | | BALANCE | BALANCE | BALANCE | BALANCE | BALANCE |
| | TOTAL | | 100 | 100 | 100 | 100 | 100 |
| | | | DYE | DYE | DYE | DYE | DYE |
| | | | DISPERSION | DISPERSION | DISPERSION | DISPERSION | DISPERSION |
| | | | LIQUID 6 | LIQUID 7 | LIQUID 8 | LIQUID 9 | LIQUID 10 |
| DYE | SUBLIMATION | DISPERSE ORANGE 25 | 15 | 15 | 15 | 15 | 15 |
| DISPERSION | DYE | DISPERSE ORANGE 80 | | | | | |
| LIQUID | | DISPERSE BROWN 27 | | | | | |
| (PERCENT BY | | SOLVENT ORANGE 60 | | | | | |
| MASS) | | SOLVENT VIOLET 13 | | | | | |
| | | DISPERSE VIOLET 28 | | | | | |
| | | DISPERSE YELLOW 54 | | | | | |
| | ANIONIC | NAPHTHALENESULFONIC | | 15 | 15 | 15 | 15 |
| | DISPERSANT | ACID FORMALIN | | | | | |
| | | CONDENSATE Na | | | | | |
| | | BUTYLNAPHTHALENE- | | | | | |
| | | SULFONIC ACID | | | | | |
| | | FORMALIN CONDENSATE | | | | | |
| | | Na | | | | | |
| | | LIGNIN SULFONIC ACID | 15 | | | | |
| | | Na | | | | | |
| | PHENYLAZO | DISPERSE ORANGE 30 | | | | | |
| | COMPOUND | DISPERSE ORANGE 31 | | | | | |
| | | DISPERSE ORANGE 73 | 1.5 | 1.5 | 1.5 | 1.5 | 1.5 |
| | PURE WATER | | BALANCE | BALANCE | BALANCE | BALANCE | BALANCE |
| | TOTAL | | 100 | 100 | 100 | 100 | 100 |
| | | | DYE | DYE | DYE | DYE | DYE |
| | | | DISPERSION | DISPERSION | DISPERSION | DISPERSION | DISPERSION |
| | | | LIQUID 11 | LIQUID 12 | LIQUID 13 | LIQUID 14 | LIQUID 15 |
| DYE | SUBLIMATION | DISPERSE ORANGE 25 | 15 | 15 | 15 | | |
| DISPERSION | DYE | DISPERSE ORANGE 80 | | | | 15 | 15 |
| LIQUID | | DISPERSE BROWN 27 | | | | | |
| (PERCENT BY | | SOLVENT ORANGE 60 | | | | | |
| MASS) | | SOLVENT VIOLET 13 | | | | | |
| | | DISPERSE VIOLET 28 | | | | | |
| | | DISPERSE YELLOW 54 | | | | | |
| | ANIONIC | NAPHTHALENESULFONIC | 15 | 15 | 15 | 15 | 15 |
| | DISPERSANT | ACID FORMALIN | | | | | |
| | | CONDENSATE Na | | | | | |
| | | BUTYLNAPHTHALENE- | | | | | |
| | | SULFONIC ACID | | | | | |
| | | FORMALIN CONDENSATE | | | | | |
| | | Na | | | | | |
| | | LIGNIN SULFONIC ACID | | | | | |
| | | Na | | | | | |
| | PHENYLAZO | DISPERSE ORANGE 30 | | | | | |
| | COMPOUND | DISPERSE ORANGE 31 | | | | | |
| | | DISPERSE ORANGE 73 | 1.5 | 1.5 | 1.5 | | 1.5 |
| | PURE WATER | | BALANCE | BALANCE | BALANCE | BALANCE | BALANCE |
| | TOTAL | | 100 | 100 | 100 | 100 | 100 |
| | | | DYE | DYE | DYE | DYE | DYE |
| | | | DISPERSION | DISPERSION | DISPERSION | DISPERSION | DISPERSION |
| | | | LIQUID 16 | LIQUID 17 | UQUID 18 | LIQUID 19 | LIQUID 20 |
| DYE | SUBLIMATION | DISPERSE ORANGE 25 | | | | | |
| DISPERSION | DYE | DISPERSE ORANGE 80 | | | | | |
| LIQUID | | DISPERSE BROWN 27 | 15 | 15 | | | |
| (PERCENT BY | | SOLVENT ORANGE 60 | | | 15 | | |
| MASS) | | SOLVENT VIOLET 13 | | | | 15 | |
| | | DISPERSE VIOLET 28 | | | | | 15 |
| | | DISPERSE YELLOW 54 | | | | | |
| | ANIONIC | NAPHTHALENESULFONIC | 15 | 15 | 15 | 15 | 15 |
| | DISPERSANT | ACID FORMALIN | | | | | |
| | | CONDENSATE Na | | | | | |
| | | BUTYLNAPHTHALENE- | | | | | |
| | | SULFONIC ACID | | | | | |
| | | FORMALIN CONDENSATE | | | | | |
| | | Na | | | | | |
| | | LIGNIN SULFONIC ACID | | | | | |
| | | Na | | | | | |
| | PHENYLAZO | DISPERSE ORANGE 30 | | | | | |
| | COMPOUND | DISPERSE ORANGE 31 | | | | | |
| | | DISPERSE ORANGE 73 | | 1.5 | | | |

| | | | | | |
|---|---|---|---|---|---|
| PURE WATER | BALANCE | BALANCE | BALANCE | BALANCE | BALANCE |
| TOTAL | 100 | 100 | 100 | 100 | 100 |

TABLE 2

| | | | DYE | DYE | DYE | DYE | DYE |
|---|---|---|---|---|---|---|---|
| | | | LIQUID 21 | LIQUID 22 | LIQUID 23 | LIQUID 24 | LIQUID 25 |
| | | | DISPERSION | DISPERSION | DISPERSION | DISPERSION | DISPERSION |
| DYE | SUBLIMATION | DISPERSE ORANGE 25 | 15 | 15 | 15 | 15 | |
| DISPERSION | DYE | DISPERSE ORANGE 80 | | | | | |
| LIQUID | | DISPERSE BROWN 27 | | | | | |
| (PERCENT | | SOLVENT ORANGE 60 | | | | | |
| BY MASS) | | SOLVENT VIOLET 13 | | | | | |
| | | DISPERSE VIOLET 28 | | | | | |
| | | DISPERSE YELLOW 54 | | | | | 15 |
| | ANIONIC | NAPHTHALENESULFONIC | 15 | 15 | 15 | 15 | 15 |
| | DISPERSANT | ACID FORMALIN | | | | | |
| | | CONDENSATE Na | | | | | |
| | | BUTYLNAPHTHALENE- | | | | | |
| | | SULFONIC ACID | | | | | |
| | | FORMALIN | | | | | |
| | | CONDENSATE Na | | | | | |
| | | LIGNIN SULFONIC ACID Na | | | | | |
| | PHENYLAZO | DISPERSE ORANGE 30 | | | | | |
| | COMPOUND | DISPERSE ORANGE 31 | | | | | |
| | | DISPERSE ORANGE 73 | | 1.5 | 1.5 | 1.5 | |

| | | | | | |
|---|---|---|---|---|---|
| PURE WATER | BALANCE | BALANCE | BALANCE | BALANCE | BALANCE |
| TOTAL | 100 | 100 | 100 | 100 | 100 |

1.2. Preparation of Inks 1 to 25

### Examples 1 to 20, Comparative Examples 1 to 4, and Reference Example 1

Components were charged in a mixture preparation tank to have one of the compositions shown in Tables 3 and 4 and were then mixed and stirred for 2 hours by a stirrer. Subsequently, filtration was performed using a membrane filter having a pore size of 1 pm, so that inks 1 to 25 were each obtained as the ink composition. In addition, the numerical values of the components shown in Tables 3 and 4 each represent percent by mass.

In addition, the components shown in Tables 3 and 4 are as shown below.

### Disperse Dye

The dye dispersion liquids 1 to 25 obtained as described above were respectively used. In addition, in Tables 3 and 4, the numbers of “BLENDED DYE DISPERSION LIQUID” respectively correspond to the numbers of the dye dispersion liquids 1 to 25 obtained as described above. In addition, the “BLENDING AMOUNT” indicates an amount of the dye dispersion liquid blended in the ink composition.

### Water-Based Organic Solvent

GLYCERIN
PROPYLENE GLYCOL

### Silicone-Based Surfactant

BYK-348 BYK (registered trademark)-348 (trade name, manufactured by BYK Japan KK) Anionic Surfactant
EMAL 327 EMAL (registered trademark) 327 (trade name, sodium polyoxyethylene alkyl ether sulfate, number of carbon atoms of alkyl group: 12, polymerization number of ethylene oxide units: 3, effective component: 27%, manufactured by Kao Corporation)
EMAL 170J EMAL (registered trademark) 170J (trade name, sodium polyoxyethylene alkyl ether sulfate, number of carbon atoms of alkyl group: 12, polymerization number of ethylene oxide units: 1, effective component: 70%, manufactured by Kao Corporation)
LATEMURU WX Latemuru (registered trademark) WX (trade name, sodium polyoxyethylene alkenyl ether sulfate, number of carbon atoms of alkenyl group: 18 to 38, polymerization number of ethylene oxide units: 1 to 23, effective component: 26%, manufactured by Kao Corporation)
NIKKOL DDP-10 NIKKOL (registered trademark) DDP-10 (trade name, sodium polyoxyethylene alkyl ether phosphate, number of carbon atoms of alkyl group: 12 to 15, polymerization number of ethylene oxide units: 10, effective component: 100%, manufactured by Nikko Chemicals Co., Ltd.) SM-210 SM-210 (trade name, polyoxyethylene tristyrenated phenyl ether sulfate, polymerization number of ethylene oxide units: 15 to 16, effective component: 100%, manufactured by Toho Chemical Industry Co., Ltd.)
NIKKOL SCS NIKKOL (registered trademark) SCS (trade name, sodium cetyl sulfate, number of carbon atoms of alkyl group: 16, polymerization number of ethylene oxide units: 0, effective component: 100%, manufactured by Nikko Chemicals Co., Ltd.)

### Nonionic Surfactant

B65-250 Conion (registered trademark) B65-250 (trade name, polyoxyethylene alkyl ether, number of carbon atoms of alkyl group: 22, polymerization number of ethylene oxide units: 25, effective component: 100%, manufactured by New Japan Chemical Co., Ltd.)

| | | | EXAMPLE | EXAMPLE | EXAMPLE | EXAMPLE | EXAMPLE |
|---|---|---|---|---|---|---|---|
| | | | 1 | 2 | 3 | 4 | 5 |
| | | | INK 1 | INK 2 | INK 3 | INK 4 | INK 5 |
| INK JET INK | DYE | BLENDED DYE | 1 | 2 | 3 | 4 | 5 |
| COMPOSITION | DISPERSION | DISPERSION | | | | | |
| (PERCENT BY | LIQUID | LIQUID | | | | | |
| MASS) | | BLENDING | 20 | 20 | 20 | 20 | 20 |
| | | AMOUNT | | | | | |
| | WATER- | GLYCERIN | 15 | 15 | 15 | 15 | 15 |
| | SOLUBLE | PROPYLENE | 10 | 10 | 10 | 10 | 10 |
| | ORGANIC | GLYCOL | | | | | |
| | SOLVENT | | | | | | |
| | SILICONE- | BYK348 | 0.5 | 0.5 | 0.5 | 0.5 | 0.5 |
| | BASED | | | | | | |
| | SURFACTANT | | | | | | |
| | ANIONIC | EMAL 327 | 1.0 | 0.5 | 0.5 | 0.5 | 1.0 |
| | SURFACTANT | EMAL 170J | | | | | |
| | | LATEMURU WX | | | | | |
| | | NIKKOL DDP-10 | | | | | |
| | | SM-210 | | | | | |
| | | NIKKOL SCS | | | | | |
| | NONIONIC | B65-250 | | | | | |
| | SURFACTANT | | | | | | |
| | PURE WATER | | BALANCE | BALANCE | BALANCE | BALANCE | BALANCE |
| | TOTAL | | 100 | 100 | 100 | 100 | 100 |
| | | | EXAMPLE | EXAMPLE | EXAMPLE | EXAMPLE | EXAMPLE |
| | | | 6 | 7 | 8 | 9 | 10 |
| | | | INK 6 | INK 7 | INK 8 | INK 9 | INK 10 |
| INK JET INK | DYE | BLENDED DYE | 6 | 7 | 8 | 9 | 10 |
| COMPOSITION | DISPERSION | DISPERSION | | | | | |
| (PERCENT BY | LIQUID | LIQUID | | | | | |
| MASS) | | BLENDING | 20 | 20 | 20 | 20 | 20 |
| | | AMOUNT | | | | | |
| | WATER- | GLYCERIN | 15 | 15 | 15 | 15 | 15 |
| | SOLUBLE | PROPYLENE | 10 | 10 | 10 | 10 | 10 |
| | ORGANIC | GLYCOL | | | | | |
| | SOLVENT | | | | | | |
| | SILICONE- | BYK348 | 0.5 | 0.5 | 0.5 | 0.5 | 0.5 |
| | BASED | | | | | | |
| | SURFACTANT | | | | | | |
| | ANIONIC | EMAL 327 | 1.0 | 5.0 | | | |
| | SURFACTANT | EMAL 170J | | | 0.1 | 0.5 | |
| | | LATEMURU WX | | | | | 0.5 |
| | | NIKKOL DDP-10 | | | | | |
| | | SM-210 | | | | | |
| | | NIKKOL SCS | | | | | |
| | NONIONIC | B65-250 | | | | | |
| | SURFACTANT | | | | | | |
| | PURE WATER | | BALANCE | BALANCE | BALANCE | BALANCE | BALANCE |
| | TOTAL | | 100 | 100 | 100 | 100 | 100 |
| | | | EXAMPLE | EXAMPLE | EXAMPLE | EXAMPLE | EXAMPLE |
| | | | 11 | 12 | 13 | 14 | 15 |
| | | | INK 11 | INK 12 | INK 13 | INK 14 | INK 15 |
| INK JET INK | DYE | BLENDED DYE | 11 | 12 | 13 | 14 | 15 |
| COMPOSITION | DISPERSION | DISPERSION | | | | | |
| (PERCENT BY | LIQUID | LIQUID | | | | | |
| MASS) | | BLENDING | 20 | 20 | 20 | 20 | 20 |
| | | AMOUNT | | | | | |
| | WATER- | GLYCERIN | 15 | 15 | 15 | 15 | 15 |
| | SOLUBLE | PROPYLENE | 10 | 10 | 10 | 10 | 10 |
| | ORGANIC | GLYCOL | | | | | |
| | SOLVENT | | | | | | |
| | SILICONE- | BYK348 | 0.5 | 0.5 | 0.5 | 0.5 | 0.5 |
| | BASED | | | | | | |
| | SURFACTANT | | | | | | |
| | ANIONIC | EMAL 327 | | | | 1.0 | 1.0 |
| | SURFACTANT | EMAL 170J | | | | | |
| | | LATEMURU WX | 2.0 | | | | |
| | | NIKKOL DDP-10 | | 0.5 | | | |
| | | SM-210 | | | 0.5 | | |
| | | NIKKOL SCS | | | | | |
| | NONIONIC | B65-250 | | | | | |
| | SURFACTANT | | | | | | |
| | PURE WATER | | BALANCE | BALANCE | BALANCE | BALANCE | BALANCE |
| | TOTAL | | 100 | 100 | 100 | 100 | 100 |
| | | | EXAMPLE | EXAMPLE | EXAMPLE | EXAMPLE | EXAMPLE |
| | | | 16 | 17 | 18 | 19 | 20 |
| | | | INK 16 | INK 17 | INK 18 | INK 19 | INK 20 |
| INK JET INK | DYE | BLENDED DYE | 16 | 17 | 18 | 19 | 20 |
| COMPOSITION | DISPERSION | DISPERSION | | | | | |
| (PERCENT BY | LIQUID | LIQUID | | | | | |
| MASS) | | BLENDING | 20 | 20 | 20 | 20 | 20 |
| | | AMOUNT | | | | | |
| | WATER- | GLYCERIN | 15 | 15 | 15 | 15 | 15 |
| | SOLUBLE | PROPYLENE | 10 | 10 | 10 | 10 | 10 |
| | ORGANIC | GLYCOL | | | | | |
| | SOLVENT | | | | | | |
| | SILICONE- | BYK348 | 0.5 | 0.5 | 0.5 | 0.5 | 0.5 |
| | BASED | | | | | | |
| | SURFACTANT | | | | | | |
| | ANIONIC | EMAL 327 | | | | | |
| | SURFACTANT | EMAL 170J | | | 0.5 | 0.5 | 0.5 |
| | | LATEMURU WX | 0.5 | 0.5 | | | |
| | | NIKKOL DDP-10 | | | | | |
| | | SM-210 | | | | | |
| | | NIKKOL SCS | | | | | |
| | NONIONIC | B65-250 | | | | | |
| | SURFACTANT | | | | | | |

| | | | | | |
|---|---|---|---|---|---|
| PURE WATER | BALANCE | BALANCE | BALANCE | BALANCE | BALANCE |
| TOTAL | 100 | 100 | 100 | 100 | 100 |

TABLE 4

| | | | COM- | COM- | COM- | COM- | REF- |
|---|---|---|---|---|---|---|---|
| | | | PARATIVE | PARATIVE | PARATIVE | PARATIVE | ERENCE |
| | | | EXAMPLE 1 | EXAMPLE 2 | EXAMPLE 3 | EXAMPLE 4 | EXAMPLE 1 |
| | | | INK 21 | INK 22 | INK 23 | INK 23 | INK 25 |
| INK JET INK | DYE DISPERSION | BLENDED DYE | 21 | 22 | 23 | 24 | 24 |
| COMPOSITION | LIQUID | DISPERSION LIQUID | | | | | |
| (PERCENT BY | | BLENDING AMOUNT | 20 | 20 | 20 | 20 | 20 |
| MASS) | WATER-SOLUBLE | GLYCERIN | 15 | 15 | 15 | 15 | 15 |
| | ORGANIC | PROPYLENE GLYCOL | 10 | 10 | 10 | 10 | 10 |
| | SOLVENT | | | | | | |
| | SILICONE-BASED | BYK348 | 0.5 | 0.5 | 0.5 | 0.5 | 0.5 |
| | SURFACTANT | | | | | | |
| | ANIONIC | EMAL 327 | | | | | |
| | SURFACTANT | EMAL 170J | | | | | |
| | | LATEMURU WX | | | | | |
| | | NIKKOL DDP-10 | | | | | |
| | | SM-210 | | | | | |
| | | NIKKOL SCS | | | | 0.2 | |
| | NONIONIC | B65-250 | | | 0.2 | | |
| | SURFACTANT | | | | | | |

| | | | | | |
|---|---|---|---|---|---|
| PURE WATER | BALANCE | BALANCE | BALANCE | BALANCE | BALANCE |
| TOTAL | 100 | 100 | 100 | 100 | 100 |

### 2. Evaluation Method

### 2.1. Generation Status of Foreign Material

After 80 g of one of the inks 1 to 25 obtained as described above was sealed in an ink pack (ink receiving amount: 200 ml) formed using a polyethylene as an inner wall material, the ink pack was left for 5 days in an environment at a temperature of 60° C. while the inner walls of the ink pack were in a close contact with the ink. An inner wall contact area of the ink pack was set to 50 cm².

After the ink pack was left as described above, the inks 1 to 25 were each filtrated using a metal mesh filter having an opening diameter of 10 μm, and the number of solid substances remaining on the metal mesh filter per 1 mm square was counted. Subsequently, the generation status of foreign material was evaluated in accordance with the following evaluation criteria. In addition, as the number of foreign material thus generated is increased, the dispersion stability is considered to be degraded. The results thus obtained are shown in Tables 5 and 6.

### Evaluation Criteria

A: Number of solid substances per 1 mm square is less than 5.
B: Number of solid substances per 1 mm square is 5 to less than 30.
C: Number of solid substances per 1 mm square is 30 or more.

### 2.2. Foaming Property

After 30 g of one of the inks 1 to 25 obtained as described above was received in a 110-m1 LABORAN Screw Tube Bottle (manufactured by AS ONE CORPORATION), the tube bottle was left still until a bubble layer disappeared on the liquid surface of the ink. This tube bottle was shook 30 times for 10 seconds and was then placed on a horizontal surface. A height of bubbles present on the liquid surface immediately after the placement was measured, and in accordance with the following evaluation criteria, a foaming property was evaluated. The evaluation results thus obtained are shown in Tables 5 and 6.

### Evaluation Criteria

A: less than 20 mm
B: 20 to less than 30 mm
C: 30 mm or more

| | | EXAMPLE | EXAMPLE | EXAMPLE | EXAMPLE | EXAMPLE | EXAMPLE | EXAMPLE |
|---|---|---|---|---|---|---|---|---|
| | | INK 1 | INK 2 | INK 3 | INK 4 | INK 5 | INK 6 | INK 7 |
| EVALUATION | GENERATION STATUS | B | A | A | A | A | A | A |
| RESULT | OF FOREIGN MATERIAL | | | | | | | |
| | FOAMING PROPERTY | A | A | A | A | A | A | B |
| | | EXAMPLE | EXAMPLE | EXAMPLE | EXAMPLE | EXAMPLE | EXAMPLE | EXAMPLE |
| | | INK 8 | INK 9 | INK 10 | INK 11 | INK 12 | INK 13 | INK 14 |
| EVALUATION | GENERATION STATUS | B | A | A | A | B | B | B |
| RESULT | OF FOREIGN MATERIAL | | | | | | | |
| | FOAMING PROPERTY | B | B | A | A | A | A | A |

| | | EXAMPLE | EXAMPLE | EXAMPLE | EXAMPLE | EXAMPLE | EXAMPLE |
|---|---|---|---|---|---|---|---|
| | | INK 15 | INK 16 | INK 17 | INK 18 | INK 19 | INK 20 |
| EVALUATION | GENERATION STATUS | A | B | A | A | A | A |
| RESULT | OF FOREIGN MATERIAL | | | | | | |
| | FOAMING PROPERTY | A | A | A | B | B | B |

TABLE 6

| | | COMPARATIVE | COMPARATIVE | COMPARATIVE | COMPARATIVE | REFERENCE |
|---|---|---|---|---|---|---|
| | | EXAMPLE 1 | EXAMPLE 2 | EXAMPLE 3 | EXAMPLE 4 | EXAMPLE 1 |
| | | INK 21 | INK 22 | INK 23 | INK 24 | INK 25 |
| EVALUATION | GENERATION | C | C | C | C | A |
| RESULT | STATUS OF | | | | | |
| | FOREIGN | | | | | |
| | MATERIAL | | | | | |
| | FOAMING | A | A | A | C | A |
| | PROPERTY | | | | | |

As shown in Tables 5 and 6, it is found that according to the ink composition of this embodiment, an ink composition which can effectively prevent the generation of foreign material can be obtained.

From the comparison between Example 1 and Examples 2 to 4, the comparison between Example 14 and Example 15, and the comparison between Example 16 and Example 17, it is found that since the phenylazo compound is contained in the ink composition, according to this ink composition, the effect to improve the dispersion stability of the dye is further enhanced, and the generation of foreign material in the ink receiving body can be more effectively prevented.

From the comparison between Example 4 and Comparative Example 2, it is found that when the content of the anionic surfactant with respect to the total mass of the ink composition is 0.05 to 2.0 percent by mass, an ink composition which can effectively prevent the generation of foreign material can be obtained. In addition, from the comparison between Example 4 and Example 7, it is found that when the content of the anionic surfactant with respect to the total mass of the ink composition is 0.05 to 2.0 percent by mass, the ink composition tends to have a more excellent low foaming property.

What is claimed is:

1. An ink jet ink composition comprising:
a sublimation dye;
an anionic dispersant; and
an anionic surfactant,
wherein the sublimation dye includes at least one selected from the group consisting of C.I. Disperse Orange C.I. Disperse Orange 80, C.I. Disperse Brown 27, C.I. Solvent Orange 60, C.I. Solvent Violet 13, and C.I. Disperse Violet 28, and
the anionic surfactant includes at least one selected from the group consisting of a polyoxyethylene alkyl ether sulfate, a polyoxyethylene alkenyl ether sulfate, a polyoxyethylene aryl ether sulfate, and a polyoxyethylene alkyl ether phosphate.

2. The ink jet ink composition according to claim 1,
wherein a total content of the polyoxyethylene alkyl ether sulfate, the polyoxyethylene alkenyl ether sulfate, the polyoxyethylene aryl ether sulfate, and the polyoxyethylene alkyl ether phosphate with respect to a total mass of the ink composition is 0.05 to 2.0 percent by mass.

3. The ink jet ink composition according to claim 1,
wherein the anionic surfactant includes a compound represented by the following formula (1),
R₁O(CH₂CH₂O)ₘSO₃⁻M⁺ (1)
where in the formula (1), R₁ represents an alkyl group having 10 to 50 carbon atoms, an alkenyl group having 10 to carbon atoms, or an aryl group having 10 to 50 carbon atoms, M⁺ represents an alkali metal ion, and m represents an integer of 1 to 30.

4. The ink jet ink composition according to claim 1,
wherein the anionic dispersant includes at least one selected from the group consisting of a compound represented by the following formula (2), a naphthalenesulfonic acid formalin condensate sodium salt, and a sodium lignosulfonate, 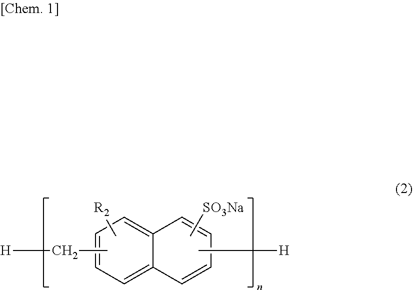
where in the formula (2), R₂ represents a monovalent hydrocarbon group having 1 to 4 carbon atoms, and n represents an integer of 1 or more.

5. The ink jet ink composition according to claim 1,
further comprising, when the sublimation dye includes at least one selected from the group consisting of the C.I. Disperse Orange 25, the C.I. Disperse Orange 80, and the C.I. Disperse Brown 27, a phenylazo compound different from the C.I. Disperse Orange 25, the C.I. Disperse Orange 80, and the C.I. Disperse Brown 27.

6. The ink jet ink composition according to claim 5,
wherein the phenylazo compound includes at least one selected from the group consisting of C.I. Disperse Orange C.I. Disperse Orange 31, and C.I. Disperse Orange 73.

7. An ink receiving body in which the ink jet ink composition according to claim 1 is received.

8. The ink receiving body according to claim 7, comprising:
a container to receive the ink composition; and
a connection member,
wherein the container is composed of a film containing a polyolefin.
